(19) United States
(12) Patent Application Publication
(10) Pub. No.: US 2012/0112530 A1
(43) Pub. Date: May 10, 2012

(54) DRIVING APPARATUS FOR A POWER CONVERSION CIRCUIT

(75) Inventors: Takeyasu KOMATSU, Chiryu-shi (JP); Tsuneo Maebara, Nagoya (JP)

(73) Assignee: DENSO CORPORATION, Kariya-city (JP)

(21) Appl. No.: 13/288,306

(22) Filed: Nov. 3, 2011

(30) Foreign Application Priority Data
Nov. 4, 2010 (JP) 2010-247130

(51) Int. Cl. B60L 1/00

(52) U.S. Cl. 307/9.1

(57) ABSTRACT

A driving apparatus is provided which drives a power conversion circuit including series-connected units of high-potential-side and low-potential-side switching elements. The apparatus includes driving circuits provided to the respective switching elements. The power conversion circuit configures a high-voltage system insulated from a low-voltage system. Each of the driving circuits outputs a fail signal indicating abnormality of at least one of the switching elements, which is driven by the driving circuit, and the driving circuit itself, to the primary side of a fail insulating unit. The secondary sides of the fail insulating units, to which the fail signal is outputted by the respective driving circuits, are connected to each other in series. The switching elements are arranged on a substrate in two rows. The fail insulating units connected to each other in series are arranged between the switching elements arranged in the two rows on the substrate.

### CROSS-REFERENCE TO RELATED APPLICATION

This application is based on and claims the benefit of priority from earlier Japanese Patent Application No. 2010-247130 filed Nov. 4, 2010, the description of which is incorporated herein by reference.

### BACKGROUND

1. Technical Field

The present invention relates to a driving apparatus for a power conversion circuit. The apparatus drives a power conversion circuit including a plurality of series-connected units of a high-potential-side switching element and a low-potential-side switching element. The apparatus includes driving circuits provided to the respective switching elements which can be turned on at the different timing.

2. Related Art

When using a motor as an in-vehicle traction unit, the motor and a power conversion circuit (inverter) connected to the motor generally configure a high-voltage system insulated from an in-vehicle low-voltage system in which a controller is installed. Hence, in a case where the controller outputs operation signals to the driving circuits, insulation means such as photocouplers are used to operate the switching elements configuring the inverter. JP-A-2007-336793 discloses a technique for arranging photocouplers and driving circuits on a substrate. In this technique, the driving circuits for an upper-side arm and the driving circuits for a lower-side arm are arranged in two respective rows. The photocouplers are arranged on both, sides of the rows.

Meanwhile, a driving circuit is well-known which outputs a fail signal to a low-voltage system via a photocoupler when abnormality is caused in a switching element or the like. Note that, in a case where each driving circuit outputs the fail signal to a controller in the low-voltage system, the number of input terminals of the controller increases. To solve this problem, in JP-A-2009-60358, secondary sides of photocouplers, to which fail signals are outputted from driving circuits, are connected in series. Thus, the fail signals are inputted to a controller via a serial line.

Note that in a case where the fail signals are outputted via the serial line as described above, the length of the serial line becomes long when the photocouplers, to which the fail signals are outputted, are arranged on the both sides of the driving circuits. Hence, the resistance against noise of the fail signals can be lowered.

### SUMMARY

An embodiment provides a driving apparatus for a power conversion circuit which drives a power conversion circuit including a plurality of series-connected units of a high-potential-side switching element and a low-potential-side switching element, and in which insulating means outputting fail signals can appropriately be arranged.

As an aspect of the embodiment, a driving apparatus for a power conversion circuit is provided which drives the power conversion circuit including a plurality of series-connected units of a high-potential-side switching element and a low-potential-side switching element, the apparatus including driving circuits provided to the respective switching elements which are turned on at the different timing. The power conversion circuit configures an in-vehicle high-voltage system insulated from an in-vehicle low-voltage system. Each of the driving circuits outputs a fail signal indicating abnormality of at least one of the switching elements, which are driven by the driving circuit, and the driving circuit itself, to the primary side of a fail insulating unit. The secondary sides of the fail insulating units, to which the fail signal is outputted by the respective driving circuits, are connected to each other in series. The switching elements are arranged on a substrate in two rows. The fail insulating units connected to each other in series are arranged between the switching elements arranged in the two rows on the substrate.

### BRIEF DESCRIPTION OF THE DRAWINGS

In the accompanying drawings:

FIG. 1 is a circuit diagram showing a power conversion circuit according to an embodiment;

FIG. 2 is a diagram showing a driving apparatus according to the embodiment;

FIG. 3 is a plan view showing a layout of the driving apparatus according to the embodiment; and

FIGS. 4A and 4B are a sectional view and a perspective view showing an arrangement of switching elements and photocouplers according to the embodiment.

### DETAILED DESCRIPTION OF THE PREFERRED EMBODIMENTS

With reference to the accompanying drawings, hereinafter will be described an embodiment of the present invention. In the embodiment, a driving apparatus for a power conversion circuit is applied to a parallel-series hybrid electric vehicle.

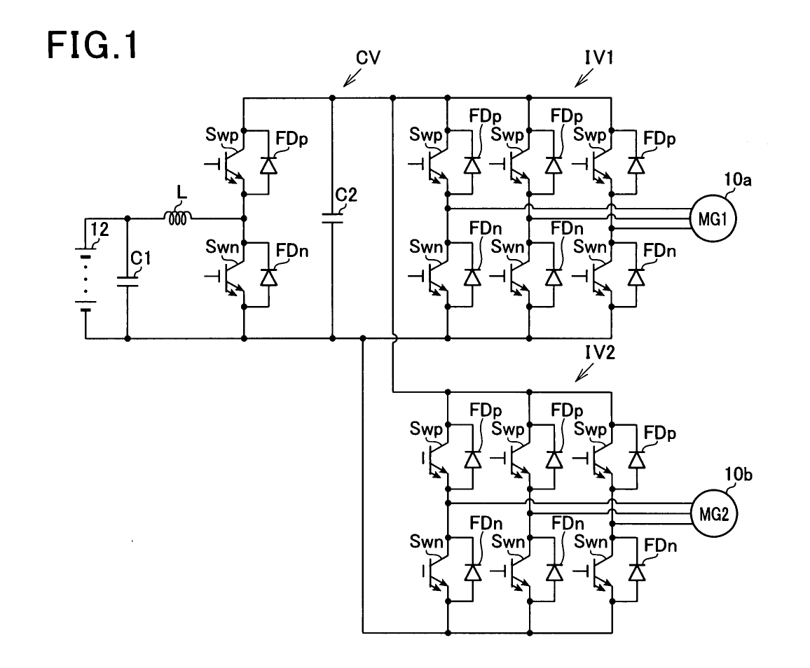

FIG. 1 shows a configuration of a power conversion circuit according to the embodiment.

A first motor generator 10a and a second motor generator 10b are mechanically connected to drive wheels and an internal combustion engine via a power dividing unit. The first motor generator 10a is connected to a high-voltage battery 12 and a capacitor C1 via an inverter IV1 and a converter CV. The second motor generator 10b is connected to the high-voltage battery 12 and the capacitor C1 via an inverter IV2 and the converter CV. Terminal voltage of the high-voltage battery 12 becomes, for example, equal to or higher than 100V.

Each of the inverters IV1 and IV2 is configured by connecting three series-connected units in parallel. Each of the series-connected units is configured by connecting a high-potential-side switching element Swp and a low-potential-side switching element Swn in series. Connecting points between the high-potential-side switching element Swp and the low-potential-side switching element Swn are connected to respective phases of the motor generator 10. An anode and a cathode of a high-potential-side free wheel diode FDp is connected between an input terminal and an output terminal (between a collector and an emitter) of the high-potential-side switching element Swp. An anode and a cathode of a low-potential-side free wheel diode FDn is connected between an input terminal and an output terminal (between a collector and an emitter) of the low-potential-side switching element Swn.

Meanwhile, the converter CV includes a series-connected unit configured of a high-potential-side switching element Swp and a low-potential-side switching element Swn, a capacitor C2 connected to the series-connected unit in parallel, and an inductor L which connects between the high-voltage battery 12 and the connecting point between the high-potential-side switching element Swp and the low-potential-side switching element Swn.

Note that all of the switching elements Sw# (#=p, n) configuring the inverters IV1 and IV2 and the converter CV are power semiconductors, especially, insulated gate bipolar transistors (IGBTs).

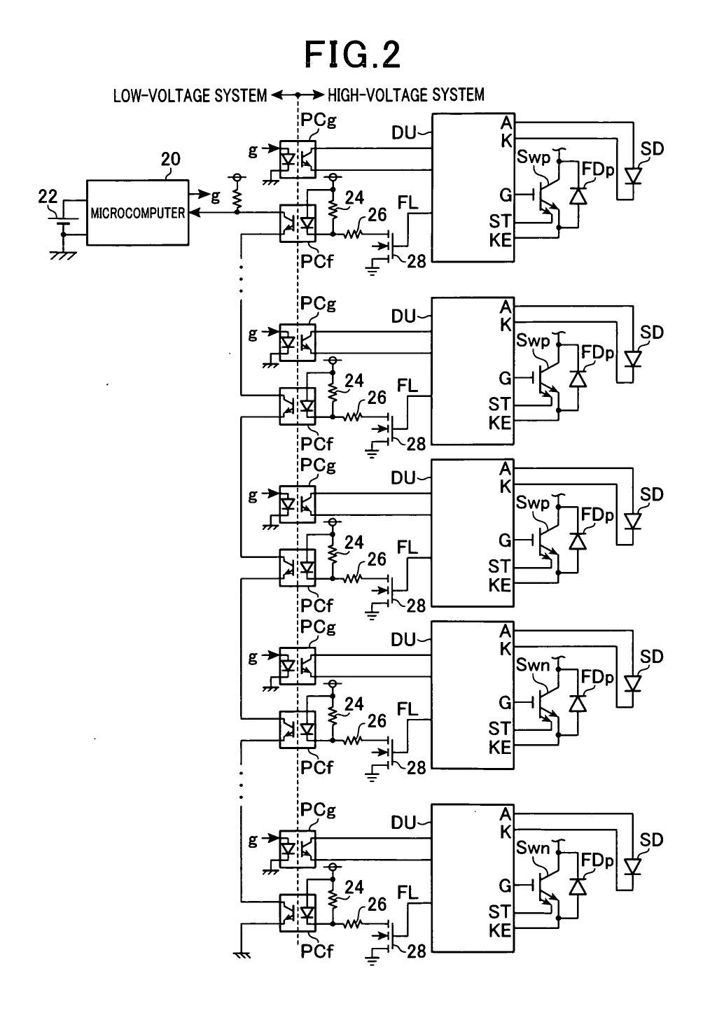

FIG. 2 shows a configuration of a driving apparatus for the switching elements Sw# configuring the inverter IV1. As shown in FIG. 2, each of the switching elements Sw# includes a conduction control terminal (gate), a sense terminal ST, and a Kelvin-emitter electrode KE, which are control terminals. The sense terminal ST outputs minute electric current correlated with current passing between an input terminal and an output terminal. The Kelvin-emitter electrode KE has the same electric potential as that of the output terminal. In addition, a temperature-sensitive diode SD is arranged near each of the switching elements Sw# to sense the temperature of the switching element Sw#.

Meanwhile, each drive unit DU is a dedicated hardware means having a function of driving the switching element Sw# and a function of monitoring presence/absence of abnormality of the switching element Sw#. The drive unit DU is connected with the gate, the sense terminal ST, and the Kelvin-emitter electrode KE of the switching element Sw#, and the anode A and the cathode D of the temperature-sensitive diode SD.

The switching elements Sw# and the drive units DU configure an in-vehicle high-voltage system insulated from an in-vehicle low-voltage system. Meanwhile, the in-vehicle low-voltage system m includes a microcomputer 20 which generates an operation signal g for the switching element Sw#. The microcomputer 20 uses a low-voltage battery 22, which has terminal voltage (e.g. ten-odd volts) lower than that of the high-voltage battery 12, as a power source.

The operation signal g outputted from the microcomputer 20 is inputted to the drive unit DU via a driving photocoupler PCg. The drive unit DU drives the switching element Sw# based on the inputted operation signal g.

The drive unit DU determines that an overcurrent abnormality has occurred based on the current flowing into the sense terminal ST if the current flowing into the switching element Sw# becomes equal to or more than a threshold. In addition, the drive unit DU determines that an excessive high temperature abnormality has occurred if the temperature sensed by the temperature-sensitive diode SD becomes equal to or more than a threshold. If it is determined that the above abnormalities have occurred or it is determined by a self-diagnostic function that abnormality of the drive unit DU has occurred, the drive unit DU outputs a fail signal FL to the primary side of a fail photocoupler PCf. The secondary sides of the fail photocouplers PCf, which correspond to the switching elements Sw# configuring the inverter IV1, are connected to each other in series. The fail signal FL is used as an off command signal for the fail photocoupler PCf. Hence, if at least one drive unit DU outputs the fail signal FL, the fact is indicated to the microcomputer 20 via the serial line.

Specifically, each of the photodiodes of the primary sides of the fail photocouplers PCf is connected with a resistor 24 in parallel. Terminals of the resistors 24 are connected to the power source. The electric potentials of the other terminals of the resistors 24 are set so as to be the same as those of the emitters of the corresponding switching elements Sw# via the resistors 26 and N channel MOS transistors (switching elements 28). Meanwhile, ends of the secondary sides of the series-connected fail photocouplers PCf are grounded, and the other ends of those are pulled up and are connected to an input terminal of the microcomputer 20. Hence, if the fail signal FL is not outputted from any of the drive units DU, the switching elements 28 become in ON-states, whereby the fail photocouplers PCf become in ON-states. Conversely, if the fail signal is FL is outputted from at least one of the drive units DU, the switching element 28 becomes in an OFF-state, whereby the fail photocoupler PCf becomes in an OFF-state. Hence, if the fail signal FL is not outputted from any of the drive units DU, a signal of logical “L” is inputted into the microcomputer 20. Conversely, if the fail signal FL is outputted from at least one of the drive units DU, a signal of logical “H” is inputted into the microcomputer 20.

Note that since the configurations of the drive units DU and the fail photocouplers PCf of the inverter IV2 and the converter CV are the same as those of the inverter IV1 shown in FIG. 2, the explanations thereof are omitted.

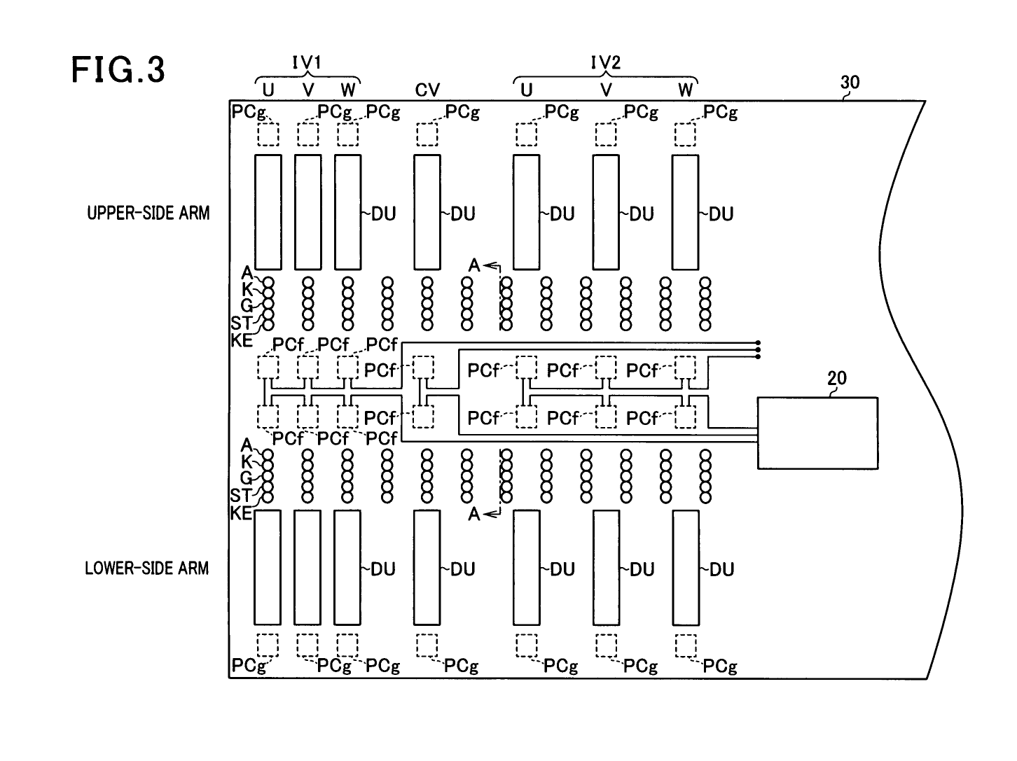

FIG. 3 is a layout of the driving apparatus according to the embodiment.

As shown in FIG. 3, in the embodiment, control terminals of the switching elements Sw# and the terminals of the so temperature-sensitive diodes SD are inserted in a line from the face of the lower side to the face of the upper side of a substrate 30. The control terminals of the switching elements Sw# and the terminals of the temperature-sensitive diodes SD corresponding to the switching elements Swp of the upper-side arm and those corresponding to the switching elements Swn of the Lower-side arm are separately arranged in a respective row. Each of the two rows has twelve fines. This is due to the configuration in which each of the number of the switching elements Swp of the upper-side arm and the number of the switching elements Swn of the lower-side arm is twelve. That is, regarding the inverter IV2 for the second motor generator 10b, two series-connected units of the high-potential-side switching element Swp and the low-potential-side switching element Swn are connected to each other in parallel for each phase. Regarding the converter CV, three series-connected units of the high-potential-side switching element Swp and the low-potential-side switching element Swn are connected to each other in parallel.

Specifically, each line corresponds to the high-potential-side switching element Swp and the low-potential-side switching element Swn which are connected to each other in series. The drive unit DU and the driving photocoupler PCg corresponding to each row are arranged outside the row. That is, with respect to each of the high-potential-side switching elements Swp and the low-potential-side switching elements Swn configuring the inverter IV1, the drive unit DU and the driving photocoupler PCg are arranged for each phase so as to be opposed to the high-potential-side switching elements Swp or the low-potential-side switching elements Swn. In addition, with respect to the three high-potential-side switching elements Swp and the three low-potential-side switching elements Swn configuring the converter CV, a single drive unit DU and a single driving photocoupler PCg are arranged so as to correspond to the three high-potential-side switching elements Swp or the three low-potential-side switching elements Swn. In addition, with respect to a pair of the high-potential-side switching elements Swp and a pair of the low-potential-side switching elements Swn configuring each phase of the inverter IV2, a drive unit DU and a driving photocoupler PCg are arranged so as to correspond to the pair of the high-potential-side switching elements Swp or the pair of the low-potential-side switching elements Swn. Note that, since the driving photocouplers PCg are arranged on the back side of the substrate 30, the driving photocouplers PCg are shown by broken lines in FIG. 3.

Meanwhile, the fail photocouplers PCf are arranged between the row of the high-potential-side switching elements Swp and the row of the low-potential-side switching elements Swn. That is, with respect to each of the high-potential-side switching elements Swp and the low-potential-side switching elements Swn configuring the inverter IV1, a fail photocoupler PCf is arranged so as to be opposed to each of the high-potential-side switching elements Swp and the low-potential-side switching elements Swn for each phase. In addition, with respect to the three high-potential-side switching elements Swp and the three low-potential-side switching elements Swn configuring the converter CV, a single fail photocoupler PCf is arranged so as to correspond to the three high-potential-side switching elements Swp, and a single fail photocoupler PCf is arranged so as to correspond to the three low-potential-side switching elements Swn. In addition, with respect to each of the high-potential-side switching elements Swp and the low-potential-side switching elements Swn configuring the inverter IV2, a fail photocoupler PCf is arranged so as to correspond to a pair of the switching elements Sw# configuring each phase (a fail photocoupler PCf is arranged so as to be opposed to a pair of the switching elements Sw# configuring each phase). Note that, since the fail photocouplers PCf are arranged on the back side of the substrate 30, the fail photocouplers PCf are shown by broken lines in FIG. 3.

The secondary sides of the adjacent fail photocouplers PCf, which correspond to the inverter IV1, of each row are connected to each other in series. The rows are connected to each other in series at each end of the rows. Hence, a U-shaped line is formed. One end of the U-shaped line is grounded, and the other end of the U-shaped line is connected to the microcomputer 20. The fail photocoupler PCf corresponding to the other end is closer to the microcomputer 20 compared with other photocouplers PCf. Similarly, the secondary sides of the adjacent fail photocouplers PCf, which correspond to the inverter IV2, of the fail photocouplers PCf configuring each row are connected to each other in series. The rows are connected to each other in series at each end of the rows. Hence, a U-shaped line is formed. One end of the U-shaped fine is grounded, and the other end of the U-shaped line is connected to the microcomputer 20. The fail photocoupler PCf corresponding to the other end is also closer to the microcomputer 20 compared with other photocouplers PCf.

The adjacent fail photocouplers PCf are connected to each other to prevent lines, which connect the secondary sides of the fail photocouplers PCf to each other in series, from crossing. The fail photocoupler PCf closest to the microcomputer 20 is connected to the microcomputer 20 to shorten the length of the line. Note that, in the embodiment, respective lines of the secondary sides of the fail photocouplers PCf corresponding to the respective inverter IV1, converter CV, and inverter IV2 are arranged so as to be prevented from crossing. That is, the fail photocouplers PCf corresponding to the converter CV are arranged at the inside positions of the substrate compared with the lines of the fail photocouplers PCf corresponding to the inverter IV1. The fail photocouplers PCf corresponding to the inverter IV2 are arranged at the inside positions of the substrate 30 compared with the lines of the fail photocouplers PCf corresponding to the converter CV. Note that, although only the lines connecting the secondary sides of the fail photocouplers PCf are shown in FIG. 3 for the sake of convenience of the description, lines connecting the fail photocouplers PCf and the drive units DU exist in practice.

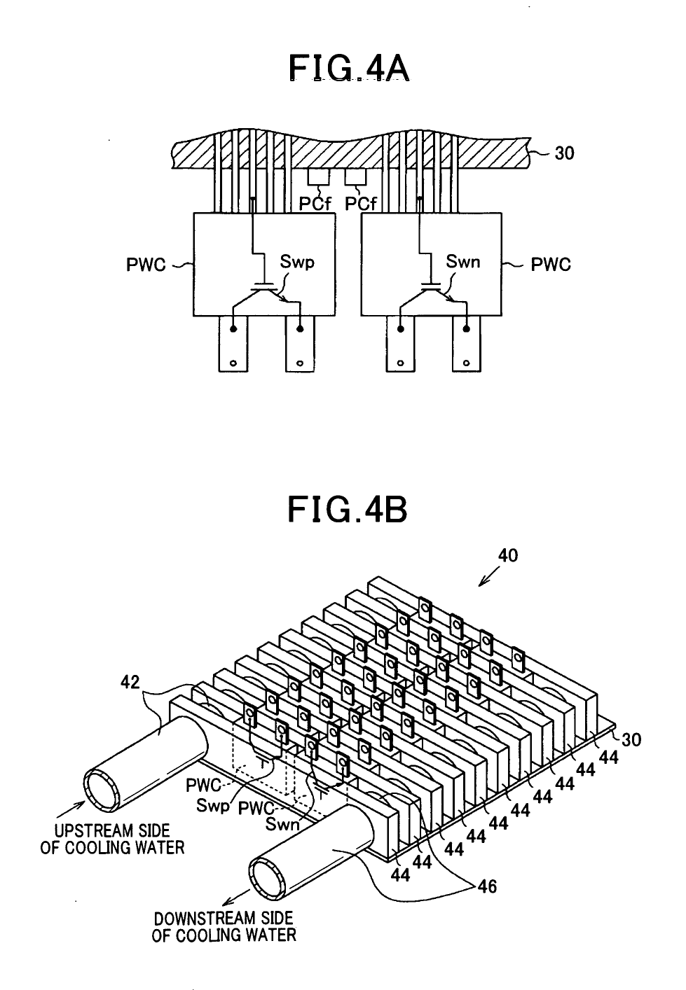

Since the fail photocouplers PCf are also arranged on the back side of the substrate 30, the fail photocouplers PCf are shown by broken lines in FIG. 3. FIG. 4A shows a sectional view cut along the line A-A of FIG. 3.

As shown FIG. 4A, each of the switching elements Sw# is packaged by being housed in a power card PWC. Although the free wheel diode FD# and the temperature-sensitive diode SD are housed in the power card PWC, the configurations are not shown in FIG. 4A. The configuration of the power card PWC housing the high-potential-side switching element Swp is identical with that of the power card PWC housing the low-potential-side switching element Swn. Specifically, in any of the power card PWC, all the gate, the Kelvin-emitter electrode, the sense terminal, and the terminals of the anode and the cathode of the temperature-sensitive diode SD are densely arranged on one side with respect to the center of the main surface of the power card PWC (collector terminal side in FIG. 4A). The fail photocouplers PCf are arranged in the space between the terminals of the high-potential-side power card PWC and the terminals of the low-potential-side power card PWC.

As shown in FIG. 4B, the power cards PWC are arranged in a cooling unit 40. The cooling unit 40 has a structure in which cooling water flowing therein from an inlet 42 is discharged from an outlet 46 through cooling passages 44. Each power card PWC is arranged so as to be interposed between each pair of the cooling passages 44.

According to the above configuration, since the fail photocouplers PCf can be arranged on a side of the substrate 30 where the temperature becomes relatively low, the fail photocouplers PCf can be appropriately prevented from deteriorating.

Furthermore, according to the arrangement of the fail photocouplers PCf shown in FIG. 3, the length of the line connecting the secondary sides of the fail photocouplers PCf can be shortened compared with the case where the fail photocouplers PCf are arranged outside the rows as in the case of the driving photocouplers PCg. Hence, the resistance against noise can be improved. Furthermore, even when the space is reduced between the switching elements Swp and Swn which are arranged in the two rows according to the recent tendency to miniaturize the power card PWC, the space can be effectively utilized. Incidentally, if the tendency of miniaturization progresses, a power source of the drive unit DU or the like becomes difficult to arrange in the space.

According to the embodiment described above, the following advantages can be obtained.

(1) The fail photocouplers PCf are arranged between the switching elements Swp and Swn arranged in two rows on the substrate 30. Hence, the length of the line connecting the secondary sides of the fail photocouplers PCf in series can be shortened. Hence, the resistance against noise can be improved.

(2) The adjacent fail photocouplers PCf of each row are connected to each other in series. Hence, lines connecting the secondary sides of the fail photocouplers PCf to each other in series are easily prevented from crossing. Hence, the resistance against noise can be improved. In addition, multi-layering of a wiring layer can be prevented.

(3) The fail photocoupler PCf, which is located at end of the fail photocouplers PCf configured in U-shape by connecting the secondary sides thereof, is closest to the microcomputer 20. Hence, the length of the line of the secondary side of the fail photocoupler PCf can be shortened as much as possible. Hence, the resistance against noise of the fail photocoupler PCf can be improved.

(4) The fail photocouplers PCf are provided on one of a pair of the faces of the substrate 30, which is opposed to the cooling unit 40. Hence, the temperatures of the fail photocouplers PCf are appropriately prevented from becoming excessively high.

(5) The driving photocouplers PCg are provided outside of the switching elements Swp and Swn which are arranged on the substrate 30 in two rows. Hence, lines respectively connected to the driving photocoupler PCg and the fail photocoupler PCf are appropriately prevented from interfering with each other.

(6) The driving photocouplers PCg are provided on one of a pair of the faces of the substrate 30, which is opposed to the cooling unit 40. Hence, the temperatures of the driving photocouplers PCg are appropriately prevented from becoming excessively high.

### Other Embodiments

The above embodiment may be modified as follows.

Regarding a fail insulating means (unit):

The fail insulating means is not limited to the fail photocoupler PCf, and may be, for example, a photo MOS relay. In addition, the fail insulating means is not limited to a photo insulating element, and may be a magnetic insulating element such as a transformer.

The advantage (1) above can be obtained even when the fail insulating means is arranged on the side where the cooling unit 40 is not arranged.

Regarding an operation insulating means (unit):

The operation insulating means is not limited to the driving photocoupler PCg, and may be, for example, a photo MOS relay. In addition, the operation insulating means is not limited to a photo insulating element, and may be a magnetic insulating element such as a transformer.

The advantage (1) above can be obtained even when the operation insulating means is arranged on the side where the cooling unit 40 is not arranged.

Regarding serial connection of the secondary sides of the fail insulating means:

In FIG. 3, all the secondary sides of the fail photocouplers PCf may be connected in series to output all the fail signals FL to the microcomputer 20 via a serial line.

In FIG. 3, the lines, which connect in series the secondary sides of the photocouplers PCf corresponding to the inverter IV to each other, may be arranged so as to cross the lines, which connect in series the secondary sides of the photocouplers PCf corresponding to the converter CV to each other, and the lines, which connect in series the secondary sides of the photocouplers PCf corresponding to the inverter IV2 to each other.

Regarding two rows arrangement:

The two rows of the arrangement in which the high-potential-side switching elements Swp and the low-potential-side switching elements Swn are provided are not limited to the row of the high-potential-side switching elements Swp and the row of the low-potential-side switching elements Swn. For example, the high-potential-side switching element Swp and the low-potential-side switching element Swn configuring each of the series-connected units may be assigned to the same line of the two rows for each series-connected unit. The high-potential-side switching element Swp and the low-potential-side switching element Swn configuring each of the series-connected units may not be assigned to the same line. The high-potential-side switching element Swp and the low-potential-side switching element Swn configuring one series-connected unit may be arranged in the same row.

In the above arrangement, in a case where one drive unit DU, which is connected only to the switching element Sw# (#=p, n) of one row, exists for every row and the fail insulating means is corresponding to the respective drive units DU are connected to each other in series, if the fail insulating means are respectively arranged on the both sides of the two rows, lines of the fail insulating means lengthen in the vertical direction in FIG. 3, which lowers the resistance against noise. Hence, arranging the fail insulating means between the two rows is especially effective.

Regarding the power card PWC:

The arrangement of the power cards PWC is not limited to that shown in FIG. 4A. For example, regarding the adjacent power cards PWC, the side where the control terminals are arranged may be positioned at the inner inside or the outer side of the substrate 30. In these cases, in a case where the side on which the control terminals are densely arranged is different between the high-potential-side power card PWC and the low-potential-side power card PWC, the connection of the lines become easy when the high-potential-side lines and the low-potential-side lines are arranged at the both sides of the substrate 30.

The configuration of the power card PWC is not limited to that in which the control terminals are arranged so as to be displaced to the specific side with respect to the center of the main surface of the power card PWC.

Regarding switching elements:

Each of the switching elements Sw# (#=p, n) may not be separately packaged. For example, the series-connected unit of the high-potential-side switching element Swp and the low-potential-side switching element Swn may be packaged integrally.

The switching element Sw# is not limited to an IGBT. For example, a power MOS field-effect transistor or the like may be used as the switching element Sw#.

Regarding the power conversion circuit:

The power conversion circuit (DC-AC conversion circuit) may not be connected to a rotating machine mechanically connected to drive wheels. For example, the power conversion circuit may be connected to a rotating machine incorporated in a compressor of an air conditioner which directly uses the high-voltage battery 12 as a power source.

The configuration of the power conversion circuit is not limited to that shown in FIG. 1. For example, the power conversion circuit may be a DCDC converter which decreases voltage of the high-voltage battery 12 and applies the decreased voltage to the low-voltage battery 22.

Other configurations:

The cooling method for the switching elements Sw# is not limited to a water-cooling method and may be an air cooling method.

Hereinafter, aspects of the above-described embodiments will be summarized.

As an aspect of the embodiment, a driving apparatus for a power conversion circuit is provided which drives the power conversion circuit including a plurality of series-connected units of a high-potential-side switching element and a low-potential-side switching element, the apparatus including driving circuits provided to the respective switching elements which are turned on at the different timing. The power conversion circuit configures an in-vehicle high-voltage system insulated from an in-vehicle low-voltage system. Each of the driving circuits outputs a fail signal indicating abnormality of at least one of the switching elements, which are driven by the driving circuit, and the driving circuit itself, to the primary side of a fail insulating unit. The secondary sides of the fail insulating units, to which the fail signal is outputted by the respective driving circuits, are connected to each other in series. The switching elements are arranged on a substrate in two rows. The fail insulating units connected to each other in series are arranged between the switching elements arranged in the two rows on the substrate.

According to the driving apparatus, arranging the fail insulating units between the switching elements arranged in two rows can improve the resistance against noise of the fail signal and miniaturize the driving apparatus. That is, if the fail insulating units are arranged at the both sides of the switching elements arranged in two rows, the lines connecting the secondary sides of the fail insulating units becomes long, which easily decreases the resistance against noise. In addition, since the space between the switching elements arranged in two rows is limited due to the requirement to miniaturize the switching elements or the like, the arrangement of the components tends to be restricted. Hence, when forming communication paths of fail signals by arranging the fail insulating units which can be configured as relatively small components, the small space can be effectively utilized.

In the driving apparatus, three or more lines of the switching elements are provided which are arranged on the substrate in two rows, each of the fail insulating units is arranged so as to correspond to the switching element which is driven by the driving circuit outputting the fail signal to the fail insulating unit, and the adjacent fail insulating units arranged in the respective two rows are connected to each other in series.

According to the driving apparatus, by connecting the adjacent fail insulating units arranged in the respective two rows, lines connecting the adjacent fail insulating units to each other in series can easily be prevented from crossing. Hence, the resistance against noise can be improved. In addition, multi-layering of a wiring layer can be prevented.

In the driving apparatus, the in-vehicle low-voltage system includes a controller which outputs an operation signal of the switching element to the driving circuit, the fail insulating unit corresponding to an end of one of the two rows and the fail insulating unit corresponding to an end of the other of the two rows are connected to each other, and one of the serially-connected fail insulating units, which is located at an end of the serially-connected fail insulating units, is closest to the controller.

According to the driving apparatus, since the line between the controller and the fail insulating unit can be shortened as much as possible, the line of the series-connected unit of the fail insulating units can be shortened as much as possible. Hence, the resistance against noise of the fail signal can be improved.

In the driving apparatus, the switching elements are formed on one face of the substrate and are cooled by cooling water, and the fail insulating units are formed on the one face of the substrate.

Since the cooling unit is arranged on the one face of the substrate, the temperature is prevented from rising. In the driving apparatus, by arranging the fail insulating units on the one face of the substrate, the temperatures of the fail insulating units are appropriately prevented from becoming excessively high.

In the driving apparatus, the in-vehicle low-voltage system includes a controller which outputs operation signals of the switching elements to the driving circuits via operation insulating units, and the operation insulating units are arranged on the both sides of the switching elements arranged on the substrate in two rows.

According to the driving apparatus, by arranging the operation insulating units on the both sides of the switching elements arranged on the substrate in two rows, the line of the fail insulating unit and the line of the operation insulating unit can appropriately be prevented from interfering with each other.

It will be appreciated that the present invention is not limited to the configurations described above, but any and all modifications, variations or equivalents, which may occur to those who are skilled in the art, should be considered to fall within the scope of the present invention.

What is claimed is:

1. A driving apparatus for a power conversion circuit, which drives the power conversion circuit including a plurality of series-connected units of a high-potential-side switching element and a low-potential-side switching element, the apparatus including driving circuits provided to the respective switching elements which are turned on at the different timing, wherein
the power conversion circuit configures an in-vehicle high-voltage system insulated from an in-vehicle low-voltage system,
each of the driving circuits outputs a fail signal indicating abnormality of at least one of the switching elements, which are driven by the driving circuit, and the driving circuit itself, to the primary side of a fail insulating unit,
the secondary sides of the fail insulating units, to which the fail signal is outputted by the respective driving circuits, are connected to each other in series,
the switching elements are arranged on a substrate in two rows, and
the fail insulating units connected to each other in series are arranged between the switching elements arranged in the two rows on the substrate.

2. The driving apparatus according to claim 1, wherein
three or more lines of the switching elements are provided which are arranged on the substrate in two rows,
each of the fail insulating units is arranged so as to correspond to the switching element which is driven by the driving circuit outputting the fail signal to the fail insulating unit, and
the adjacent fail insulating units arranged in the respective two rows are connected to each other in series.

3. The driving apparatus according to claim 1, wherein the in-vehicle low-voltage system includes a controller which outputs an operation signal of the switching element to the driving circuit,
the fail insulating unit corresponding to an end of one of the two rows and the fail insulating unit corresponding to an end of the other of the two rows are connected to each other, and
one of the serially-connected fail insulating units, which is located at an end of the serially-connected fail insulating units, is closest to the controller.

4. The driving apparatus according to claim 1, wherein
the switching elements are formed on one face of the substrate and are cooled by cooling water, and
the fail insulating units are formed on the one face of the substrate.

5. The driving apparatus according to claim 1, wherein
the in-vehicle low-voltage system includes a controller which outputs operation signals of the switching elements to the driving circuits via operation insulating units, and
the operation insulating units are arranged on the both sides of the switching elements arranged on the substrate in two rows.
